(19) United States
(12) Patent Application Publication
(10) Pub. No.: US 2004/0181429 A1
(43) Pub. Date: Sep. 16, 2004

(54) Method and system for administering a drug

(75) Inventor: Robert W.J. Shannon, Wellington (NZ)

Correspondence Address: BAKER BOTTS L.L.P., 2001 ROSS AVENUE, 6TH FLOOR, DALLAS, TX, 75201, US

(73) Assignee: Electronic Data Systems Corporation

(21) Appl. No.: 10/389,643

(22) Filed: Mar. 14, 2003

(51) Int. Cl. G06F 17/60

(52) U.S. Cl. 705/2; 128/898

(57) ABSTRACT

According to one embodiment of the invention, a method for administering a drug is provided. The method includes receiving information concerning a therapeutic break period of a drug. The therapeutic break period indicates a predicted range of time when the drug will reach a pre-determined level of effectiveness for a patient. The method also includes identifying a date range that corresponds to the therapeutic break period, and graphically displaying an indication of the therapeutic break period in conjunction with the date range for at least one dosage of the drug.

### TECHNICAL FIELD OF THE INVENTION

This invention relates generally to patient care and more particularly to a method and system for administering a drug.

### BACKGROUND OF THE INVENTION

Pharmaceutical drugs are widely used by healthcare facilities to treat patients. Each drug is designed to have a particular effect on a patient. Depending on the effect that is desirable on a patient, a doctor may administer a drug or a combination of drugs to the patient. For example, to alleviate certain psychological conditions, a doctor may administer one or more antipsychotic drugs to a mentally-ill patient. If the patient does not respond to the drug regimen, the doctor may change the type and/or dosage of the drug for the patient. This process may be repeated until the patient responds to the drug treatment.

A conventional process of determining an appropriate type and dosage of drug for a patient may be likened to a guessing game. Based on the generic information concerning the drug, a doctor selects a drug and a dosage of the drug for a patient. Then the doctor administers the drug to the patient and waits until the therapeutic break period of the drug is reached before determining whether the drug works. A therapeutic break period refers to an estimated time period required for the drug to take its effect. If the patient does not respond to the drug within the therapeutic break period, the doctor may try another drug regimen. This process repeats until the patient responds to a particular drug regimen. The repetition involved in determining an appropriate type and dosage of drug for the particular illness of a patient contributes to the inefficiency and cost of healthcare. Further, the patient may be overmedicated with drugs that may do not benefit the patient.

### SUMMARY OF THE INVENTION

According to one embodiment of the invention, a method for administering a drug is provided. The method includes receiving information concerning a therapeutic break period of a drug. The therapeutic break period indicates a predicted range of time when the drug will reach a pre-determined level of effectiveness for a patient. The method also includes identifying a date range that corresponds to the therapeutic break period, and graphically displaying an indication of the therapeutic break period in conjunction with the date range for at least one dosage of the drug.

Some embodiments of the invention provide numerous technical advantages. Other embodiments may realize some, none, or all of these advantages. For example, according to one embodiment, less time may be required to determine whether a particular dosage of a drug is effective for a particular patient, which may reduce the length of hospital stay and lower the cost of healthcare. In another embodiment, overmedication of a patient may be avoided. In another embodiment, a therapeutic break period that is customized for a particular patient may be determined. In another embodiment, a graph indicating a pattern of drug intake may be used to better communicate a plan of patient care to the patient and his or her family members, which may provide them a higher level of comfort and confidence.

Other advantages may be readily ascertainable by those skilled in the art.

### BRIEF DESCRIPTION OF THE DRAWINGS

Reference is now made to the following description taken in conjunction with the accompanying drawings, wherein like reference numbers represent like parts, in which:

FIG. 1 is a schematic diagram illustrating one embodiment of a system that may benefit from the teachings of the present invention;

FIG. 2 is a block diagram illustrating one embodiment of a computer system of FIG. 1;

FIG. 3A is a flow chart illustrating one embodiment of a method for administering a drug;

FIG. 3B is a flow chart illustrating additional details of the method of FIG. 3A;

FIG. 3C is a flow chart illustrating additional details of the method of FIG. 3A;

FIG. 4 is a flow chart illustrating one embodiment of a method for administering a drug; and

FIG. 5 is a schematic diagram illustrating one embodiment of a graph that may be used in conjunction with the method of FIG. 3A.

### DETAILED DESCRIPTION OF EXAMPLE EMBODIMENTS OF THE INVENTION

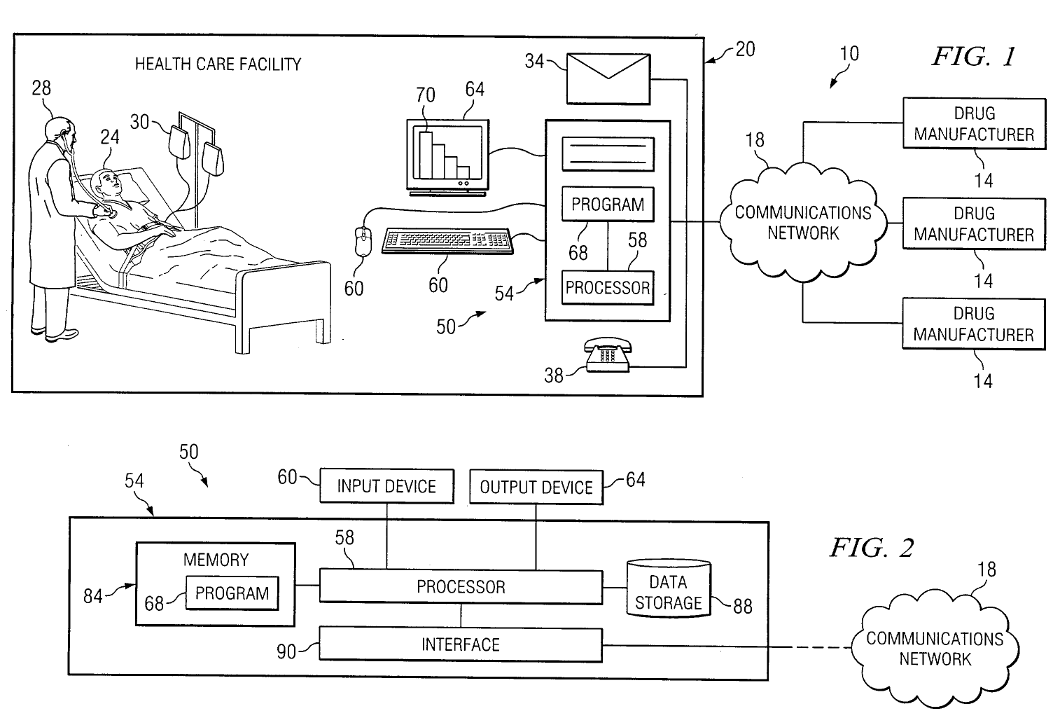

Embodiments of the invention are best understood by referring to FIGS. 1 through 5 of the drawings, like numerals being used for like and corresponding parts of the various drawings.

FIG. 1 is a schematic diagram illustrating one embodiment of a system 10 that may benefit from the teachings of the present invention. System 10 comprises one or more drug manufacturers 14, a communications network 18, and a healthcare facility 20. Drug manufacturer 14 may be any person or organization that may have information concerning a drug. For example, a pharmaceutical company that develops, manufactures and/or sells drugs may have information concerning the drugs purpose, characteristics, and application. Drug manufacturer 14 may have information concerning drugs intended for any biological subject, such as a person, animal, or plant. Communications network 18 may be any network that is operable to carry communications signals to and from different parties. Examples of communications network 18 may include internet, fiber optics network, cable network, satellite network, and public telephone networks. Healthcare facility 20 may be any agency where a patient 24 may receive healthcare from a healthcare professional 28.

As part of care provided to patient 24, healthcare professional 28 may administer one or more drugs 30 to patient 24. Although a human patient 24 is shown as an example in FIG. 1, any biological subject, such as animals and plants, may also be patient 24. Examples of healthcare professional 28 include a doctor, a nurse, a physician's assistant, and a pharmacist. For illustrative purposes, healthcare professional 28 is referred to from herein as doctor 28. Although FIG. 1 shows drug 30 as being in a liquid form that is intravenously administered to patient 24, drug 30 may be administered to patient 24 in any suitable manner. For example, drug 30 may be administered to patient 24 orally, by injection, radiation, or may be applied topically.

Drug manufacturers 14 are coupled to healthcare facility 20 over communications network 18. Drug manufacturers 14 may send information concerning one or more drugs to healthcare facility 20 using any suitable methods of communication. For example, drug information sent from drug manufacturer 14 may be received at healthcare facility 20 through regular mail 34 or a telephone 38. Using analogous communications channels, healthcare facility 20 may also request drug information from drug manufacturers 14 over communications network 18.

Information concerning drug 30 sent by drug manufacturer 14 to healthcare facility 20 may be generic. Using the generic information received from drug manufacturer 14, doctor 28 may select a drug or a combination of drugs for patient 24. Then doctor 28 may administer the selected drug to patient 24 to determine whether drug 30 works. For example, when patient 24 is diagnosed as being clinically depressed, doctor 28 may administer a drug that is described by its associated drug information as an anti-depressant. After waiting for a time period that doctor 28 feels is appropriate, doctor 28 determines whether patient 24 has responded to the drug. If patient's 24 condition has not improved, doctor 28 may try another drug regimen. This process, which may be likened to a trial and error process, repeats until patient 24 responds to a particular drug regimen.

The repetition is necessary because the generic information concerning the drug may not be reliable in many cases. For example, although quetiapine fumarate is generally known as an anti-psychotic drug, such generic information may not be helpful for predicting the effect of the drug on a particular patient having dyslexia with decreased motor neuron function and Neurolepic Malignant Syndrome. The repetition involved in determining an appropriate type and dosage of drug for the particular illness of a patient requires time and large quantities of drugs, which aggravate the rising cost of healthcare. Further, patient 28 may be overmedicated or needlessly medicated with drugs that have no beneficial effects on patient 28.

According to one embodiment of the present invention, a method and system for administering a drug to a patient are provided. In one embodiment, less time may be required to determine whether a particular dosage of a drug is effective for a particular patient, which may reduce the length of hospital stay and lower the cost of healthcare. In another embodiment, overmedication of a patient may be avoided. In another embodiment, a therapeutic break period that is customized for a particular patient may be determined. In another embodiment, a graph indicating a pattern of drug intake may be used to better communicate a plan of patient care to the patient and his or her family members, which may provide them a higher level of comfort and confidence. Additional details of example embodiments of the invention are described below in greater detail in conjunction with portions of FIG. 1 and FIGS. 2 through 5.

Referring back to FIG. 1, healthcare facility 20 may also comprise a computer system 50 that may be used to receive and process drug information from drug manufacturer 14. In one embodiment, computer system 50 may receive drug information directly from drug manufacturer 14 over communications network 18; however, computer system 50 may receive drug information through any suitable methods. For example, a user may receive drug information over regular mail 34 or telephone 38 and transfer the information to computer system 50. As shown in FIG. 1, computer system 50 comprises a computer 54 having a processor 58 and a program 68 that may be executed on processor 58 to perform one or more functions. Computer 54 is coupled to input devices 60, such as a mouse 60 or a keyboard 60, as shown in FIG. 1. Computer 54 is also coupled to an output unit 64, such as a monitor 64. Program 68 may be used to process the received drug information and display the processed information as a graph 70 shown through monitor 64. Although computer system 50 is shown as a desktop computer in FIG. 1, any computing device operable to process drug information and display the information for a user may be computer system 50. Additional details of some embodiments of computer system 50 are provided below in conjunction with FIG. 2.

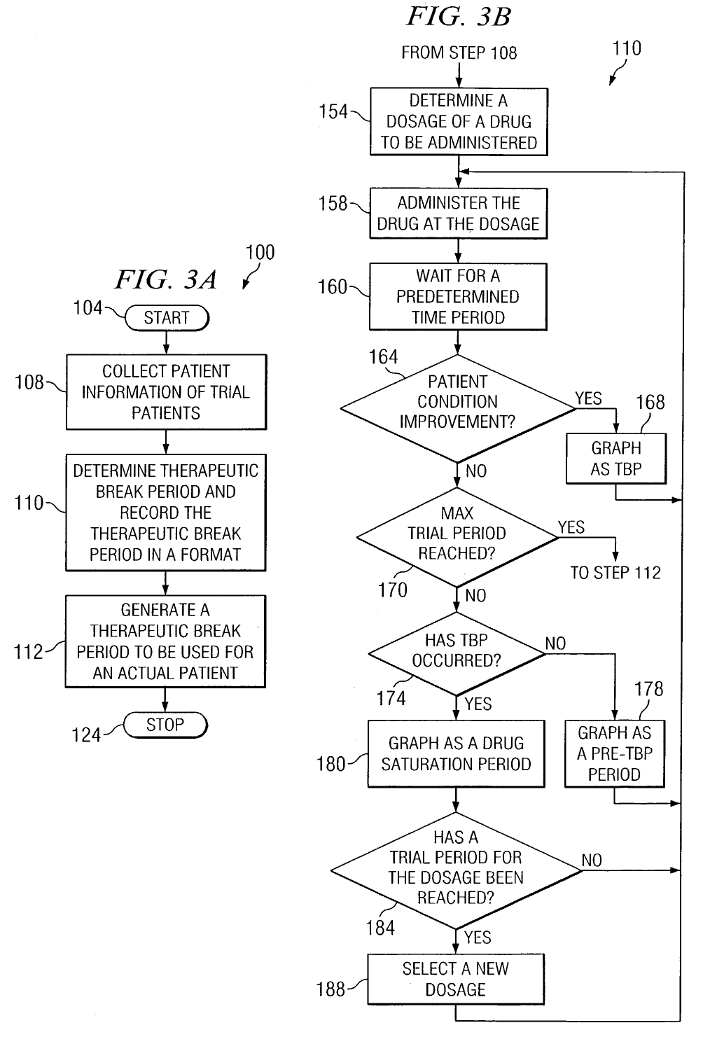

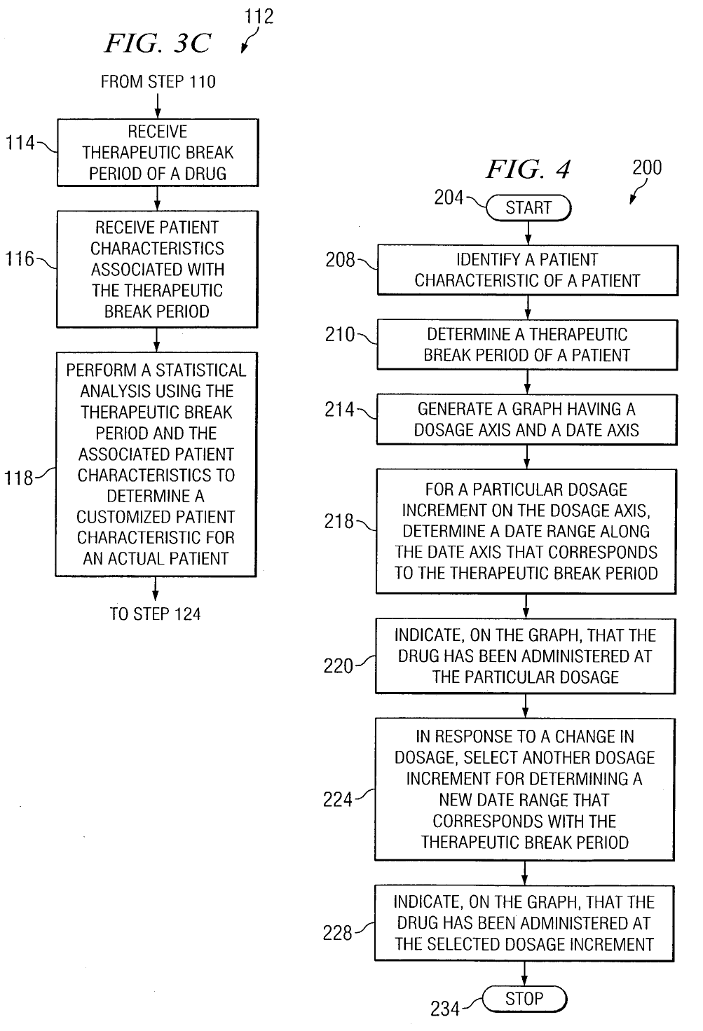

In one embodiment, program 68, when executed on processor 58, is operable to receive information concerning a therapeutic break period (“TBP” ) of a drug, identify a date range that corresponds to the TBP, and graphically display an indication of the TBP in conjunction with a date range for at least one dosage of the drug to be administered. As used herein, a therapeutic break period, or TBP, refers to a predicted range of time when a drug will reach a predetermined level of effectiveness for a patient. The predetermined level of effectiveness may be an appreciable level of improvement in a patient's condition, in one embodiment. In some embodiments, the TBP of a drug may be provided by drug manufacturer 14. Additional details concerning the determination of TBP of a drug are described below in conjunction with FIG. 3A.

In one embodiment, the received information concerning a TBP of a drug may be associated with one or more patient characteristics of patient 24. Examples of patient characteristics patient 24 are provided below as a non-exclusive list. Some or all of the information provided below may constitute patient characteristics. The list also provides other information, such as drug information, that may be relevant to the patient characteristics of patient 24.

Inputs:

1) Preliminary Information concerning the patient

a) Vital_Signs

i) Blood Pressure

ii) temperature

iii) heartrate

b) Particulars

i) Name

ii) Martial Status

iii) Children

iv) Sex

v) DOB

vi) Place of Birth

vii) Environmental Factors

c) Shape Factors

i) Height over time

(1) standard deviation

ii) Weight over time

(1) standard deviation

iii) Height: Weight Correlation

(1) standard deviation

d) Descriptors

i) Physical Appearance

ii) Emotional Response

iii) Eye Colour

iv) Hair Colour

e) Family Details

i) Father (if known)

ii) Mother (if known)

f) Physical

i) Last Results

g) Allergies

i) Type

ii) Since

iii) Last testing date

h) G.P.

i) Last Visit

ii) date

iii) condition

iv) treatment

v) case notes

i) Identifier for locating any existing health records

j) Last Admittance record#

k) Genetic Markers

2) Reference (data links to records)

a) Family History

i) Parental tree (goto 1.)

(1) Offspring (goto 1.)

ii) Sibling tree (goto 1.)

b) Case History Reference#

Drug Information:

3) Drug Class (e.g. atypical antipsychotic)

a) Drug Ref#* ______

4) Drug Type (e.g. tricyclic dibenzadiazepine derivative)

a) Drug Ref#* ______

5) Drug Class (e.g. atypical antipsychotic)

a) Drug Ref#* ______

6) Drug Brand Name (e.g. Clozaril)

a) Drug Ref#* ______

7) Drug Chemical Name (e.g. Clozapine)

a) Drug Ref#* ______

* (may detail descriptive information, molecular structure, formula, molecular weight, etc).

8) Contributors

a) Conditions

i) Family

ii) Environment

9) Use

10) Contraindications

11) Adverse Effects

12) Nullifiers

13) Precautions

14) Interactions

15) Action

a) Dose Rate

b) Tablets available

c) Syrup available

d) Recommended therapeutic dosage range

e) Half-Life

f) Symptoms/indicators

16) Symptomatic Description

a) Reference Data

17) Reference Data

a) Test Cases

b) Date

c) Quantity sampled

d) Trial Data

e) Genetic Markers

f) Withdraw indicators

Treatment History: (may include trial data)

18) Tree 1

a) Drug 1

i) Date Start

ii) Dose

iii) Expected Result

iv) Outcome

v) Date of Outcome

vi) Notes.

b) Drug 2

i) Date Start

ii) Dose

iii) Expected Result

iv) Outcome

v) Date of Outcome

vi) Notes.

19) Tree 2

a) Drug 1

i) Date Start

ii) Dose

iii) Expected Result

iv) Outcome

v) Date of Outcome

vi) Notes.

b) Drug 2

i) Date Start

ii) Dose

iii) Expected Result

iv) Outcome

v) Date of Outcome

vi) Notes.

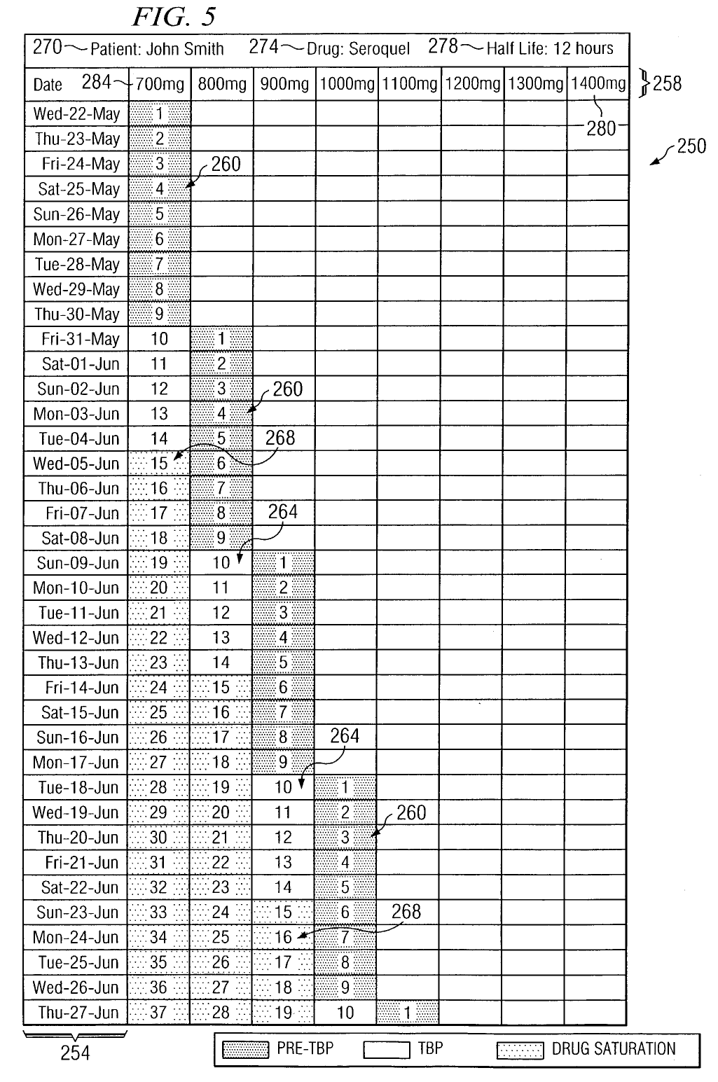

In one embodiment, using the received TBP, program 68 may be operable to determine a TBP that is customized for a particular patient 24 by performing a statistical analysis using the received TBP and the associated patient characteristics. The customized TBP may be displayed using graph 70. Program 68 may also be operable to change the information displayed by graph 70 in response to a determination by doctor 28 regarding a change in patient's 24 condition. For example, a new date range for the TBP, in conjunction with other associated information, may be displayed by program 68 in response to doctor's 28 determination that the dosage of the drug will be increased because patient 24 receiving the drug has not responded to the drug regimen. Program 68 may also be operable to initiate doctor 28 to make changes to the drug regimen by displaying appropriate information through output unit 64. For example, when the TBP has passed for a particular dosage of drug 30, program 68 may communicate to doctor 28 that TBP has already passed, which would initiate doctor 28 to either select a new dosage of the drug or select a new drug to be administered to patient 24. Program 68 may also be operable to display any patient information of patient 24 in conjunction with graph 70. Patient information may include the name of the patient, age, the type of drug that is associated with graph 70, drug half life, the maximum dosage limit of the drug, and any other pertinent information. Additional details of graph 70 are provided below in conjunction with FIG. 5.

FIG. 2 is a block diagram illustrating one embodiment of computer system 50 shown in FIG. 1. Computer system 50 comprises processor 58, memory 84 storing program 68, one or more data storage units 88, input device 60, and output device 64. Processor 58 is coupled to memory 84, data storage unit 88, input device 60, and output device 64. Processor 58 is operable to execute logic of program 68 and access data storage unit 88 to retrieve or store data related to program 68. Examples of processor 58 are Pentium processors available from Intel Corporation.

Program 68 is a computer program that controls computer system 50 shown in FIG. 1 for receiving TBP information and graphically displaying the TBP information. Program 68 may reside in any storage medium, such as memory 84 or data storage unit 88. Program 68 may be written in any suitable computer language, including C or C++.

Memory 84 and data storage unit 88 may comprise files, stacks, data bases, or any other suitable forms of data. Memory 84 and data storage unit 88 may be random access memory, read only memory, CD ROM, removable memory devices, or any other suitable devices that allow storage and/or retrieval of data. Memory 84 and storage unit 88 may be interchangeable and may perform the same functions. Input device 60 may be any device operable to provide input from a user to system 50. Output device 64 may be any device operable to communicate information generated by computer 54 to a user. Examples of output device 64 include a monitor, printer, and a speaker. Interface 90 may be any communications device that may be controlled by processor 58 to receive information from an external source over communications network 18. An example of interface 90 is a modem.

FIG. 3A is a flow chart illustrating one embodiment of a method 100 for ascertaining drug information and providing the drug information. In one embodiment, drug manufacturer 14, healthcare facility 20, and/or other persons or entities may perform some or all acts of method 100 to determine a TBP customized for a particular patient 24. The determined TBP may be provided to computer system 50 of healthcare facility 20, in one embodiment. In some embodiments, a computer system, such as system 50 may be used to perform some or all of methods 100. Method 100 starts at step 104. At step 108, patient information concerning each patient in a trial group is collected. Patient information may include patient characteristics of a patient, such as genetic markers, vitals, physical characteristics, drug intake history, and gender. For example, one patient may be identified as a male, 6 feet tall, and having brown eyes with a high blood pressure level, while another patient may be identified as a female, 5 feet 2 inches tall, and having blue eyes with normal blood pressure level. At step 110, a TBP of the drug for each patient in the trial group is determined using a suitable drug testing procedure as well known by one skilled in the art. For example, a drug may be administered to a trial patient and the time required for the drug to change the condition of the patient may be measured. The respective TBPs and patient information associated with the patients in the trial group may be maintained in an appropriate database that may be accessed by another party, such as hospital 20. In one embodiment, each TBP of a particular trial patient is associated with the patient information of the particular trial patient so that the patient information may be obtained in conjunction with the TBP. In one embodiment, the TBP may be stored as a graph. At step 112, a customized TBP for an actual patient 24 may be determined using the TBPs and patient information of trial patients having at least one patient characteristic that is similar to the actual patient 24. Step 112 may be performed using a computer that is different from computer system 50, in one embodiment. Additional details concerning step 112 are described below in conjunction with FIG. 3B. Method 100 stops at step 124.

FIG. 3B is a flow chart illustrating additional details of step 110 of method 100 shown in FIG. 3A. At step 154, a dosage of a drug to be administered is determined. At step 158, the drug is administered at the determined dosage to a trial patient. At step 160, drug manufacturer 14 may wait for a predetermined amount of time period to allow the administered dosage of the drug to take effect. The amount of time to allow the drug to take effect may be determined using any suitable drug testing procedure. At decision step 164, whether the patient condition has improved is determined. If yes, then the “yes” branch is followed to step 168 where the time period when the improvement is observed is graphed as a TBP. Then method 100 proceeds to step 158.

Referring back to decision step 164, if the patient condition has not improved, then the “no” branch is followed to decision step 170 where drug manufacturer 14 determines whether a maximum trial period has been reached. The maximum trial period refers to the entire trial period of the drug to ascertain any pertinent information regarding the drug. The maximum trial period may be determined using any suitable drug testing procedures. If the maximum trial period has not been reached, then the “no” branch is followed to decision step 174 where drug manufacturer 14 determines whether TBP has occurred previously. If no, then the “no” branch is followed to step 178 where the time when the determination is made is graphed as a time period prior to the TBP. This time period is referred to herein as “pre-TBP.” Then method 100 proceeds to step 158.

Referring back to decision step 174, if a TBP has occurred previously, then the “yes” branch is followed to step 180 where the time period during which the drug was in the trial patient's system is graphed as a drug saturation period. A drug saturation period refers to a time period when the drug is not changing a patient's condition after reaching the TBP. Then at decision step 184, drug manufacturer 14 determines whether a trial period for the particular dosage has been reached. The trial period for the particular dosage of the drug refers to a time period assigned to test the effectiveness of a particular dosage of a drug before changing the dosage and may be determined using any suitable drug testing procedure. If the trial period has been reached, then the “yes” branch is followed to step 188 where a new dosage of the drug is selected. Then method 100 proceeds to step 158. Referring back to decision step 184, if the trial period for the particular dosage for the drug has not been reached, then the “no” branch is followed back to step 158. Referring back to decision step 170, if the maximum trial period of the drug has been reached, then “yes” branch is followed to step 114, which is described above in conjunction with FIG. 3A. Although steps 168, 178, and 180 describe indicating information graphically, any suitable method of recording and/or displaying information concerning the pre-TBP, TBP, and drug saturation period may be used.

FIG. 3C is a flow chart illustrating additional details of step 112 shown in FIG. 3A. At step 114, TBP information concerning one or more trial patients is received by healthcare facility 20 from drug manufacturer 14. At step 116, patient characteristics of each trial patient is also received. At step 118, a suitable statistical analysis method for determining a customized TBP for patient 24 is performed using the received TBP information regarding the trial patients and patient characteristics of the trial patients. In one embodiment, the patient characteristic of patient 24 who will receive the drug is also used in the statistical analysis. For example, one suitable statistical analysis method may be averaging the TBP associated with all of the trial patients. In another example, the TBP of trial patients having one or more patient characteristics that are similar to those of actual patient 24 may be averaged. In another example, a weighted averaging process, where the TBP of trial patients is weighted according to the number of patient characteristics in common with actual patient 24, may also be used (giving more value to the TBP associated with trial patients having more patient characteristics that are similar to those of patient 24, for example). Any suitable process to yield a more reliable TBP for patient 24 may be used in step 118.

FIG. 4 is a flow chart illustrating one embodiment of a method of administering a drug to patient 24. In one embodiment, drug manufacturer 14 and/or other persons or entities may perform some or all acts of method 200 administer a drug. In some embodiments, a computer system, such as system 50 may be used to perform some or all of methods 200. Method 200 starts at step 204. At step 210, one or more patient characteristics of patient 24 are identified and used in conjunction with the TBP information from drug manufacturer 14 to determine a customized TBP, as described above in conjunction with step 112 of method 100. In one embodiment of step 210, healthcare facility 20 may determine a customized TBP by requesting TBP information of trial patients from drug manufacturer 14 who may have ascertained the information by performing some or all of acts described in conjunction with portions of FIGS. 3A and 3B. In another embodiment, healthcare facility 20 may perform step 110 described in conjunction with FIG. 3B to determine a database of TBPs associated with patient characteristics of trial patients and use the database to determine a customized TBP. At step 214, a graph having a dosage axis and a date axis is generated. In one embodiment, a dosage axis may indicate incrementally increasing dosage levels of a particular drug. A date axis may indicate a plurality of dates in chronological order. Although date is used as an example of a time increment, any time increment may be indicated by the date axis. As used herein, a date axis refers to an axis indicating any predetermined increments of time, such as minutes, seconds, hours, weeks, or months.

At step 218, for a particular dosage increment on the dosage axis, a date range along the date axis that corresponds to the TBP is determined. For example, the TBP may be determined at step 210 as being 10 to 14 days from the starting date of a drug regimen. Thus, if the drug regimen starts on May 22nd, then the date range along the date axis that corresponds to the TBP would be indicated as May 31st through June 4th. (see FIG. 5, for example). At step 220, the dates leading up to the date range determined at step 218 are marked to show that the drug is administered at the particular dosage up to the beginning of the TBP. The dates marked at step 220 constitute the pre-TBP. At step 224, another dosage increment is selected in response to a change in the dosage of the drug. For the new dosage increment, a new date range that corresponds with the TBP is determined. For example, if doctor 28 decides to increase the dosage from 600 mg to 800 mg after reaching the end of the date range corresponding with the TBP for 600 mg, then the dosage increment indicated as “800 mg” along the dosage axis is selected and a new date range for the TBP at 800 mg is determined based on the day when the drug is first administered at 800 mg. At step 228, the dates when the drug is administered at the new dosage increment is indicated in conjunction with the date axis. In one embodiment the dates indicated at step 228 constitute the pre-TBP. Method 200 stops at step 234.

FIG. 5 is a schematic diagram of a graph 250 that may be generated using methods 100 and/or 200 of FIGS. 3A and 4, respectively. In one embodiment, graph 250 may be generated using program 68. Graph 250 comprises a time axis 254 and a drug dosage axis 258. As shown in FIG. 5, in one embodiment, time axis 254 may indicate predetermined increments of time in chronological order. Dosage axis 258 may indicate predetermined increments of dosage levels for a drug. The time increments and dosage increments may be determined using any suitable procedure for testing drugs. Cells 260 represent a pre-TBP. Cells 264 represent the date range corresponding to the TBP. Because graph 250 describes a scenario where the TBP is 10 to 14 days, cells 264 marks the 10th day through the 14th day from the time when pre-TBP 260 starts. Although a TBP of 10 to 14 days is used as an example, the TBP may vary depending on the drug. Cells 268 indicate a drug saturation period.

As shown in FIG. 5, for each dosage increment, cells 260, 264, and 268 are positioned in chronological order, in one embodiment. Further, as shown at FIG. 5, the pre-TBP cells 260 start at gradually later times as the dosage increases, in one embodiment. For example, graph 250 shows an increase in dosage from 600 mg to 800 mg on May 31st, which is the 10th day of the drug regiment using a dosage level of 600 mg. Although the dosage is increased to 800 mg, the remaining dates corresponding to the 600 mg increment are also marked to indicate that the drug is administered, so long as a dosage of at least 600 mg is administered subsequent to the increase of the dosage. This is because administering the drug at a level greater than 600 mg necessarily means that 600 mg of the drug has been administered. For example, administering 800 mg of the drug on May 31, as shown in graph 250, means that 600 mg of the drug plus 200 mg of the drug is administered on the same day. Thus, the cell 264 corresponding to 600 mg is also marked in conjunction with the cell 260 corresponding with 800 mg.

Presenting information concerning drug in the manner shown by graph 250 is advantageous because this allows doctor 28 to determine whether the change in the condition of patient 24 is due to the drug reaching the TBP at a previous dosage or due to the increase in the dosage. For example, after starting a drug regiment using 900 milligrams of the drug and observing an improvement of the patient's condition on the 3rd day of the drug regimen (which is June 11th), doctor 28 may determine from graph 250 that the improvement of the condition is not due to the increase of the drug dosage to 900 mg but because the patient is within TBP of the drug at 800 mg, as indicated by cells 264 corresponding to 800 milligram column of graph 250. Thus, doctor 28 may decrease the dosage of the drug back to 800 milligrams, which decreases the cost of the drug and avoids overmedication of patient 24.

In some embodiments, other information may be associated with graph 250. For example, as shown in FIG. 5, patient identity information may be provided at a field 270. The identity of the drug may be provided at a field 274. At a field 278, the half life of the drug may be indicated. A half life of a drug refers the time period that the drug remains in patient's 24 system. Thus, as shown at FIG. 5, if the half life of the drug is 12 hours, then to sustain the effect of the drug for a full day, the drug would have to be administered twice a day. In one embodiment, dosage axis 258 may end at a maximum dosage limitation. For example, as shown by a reference number 280, 1400 mg is the last and the maximum level of dosage of the drug that is identified in field 274. In one embodiment, selecting a cell 260, 264, or 268 using a cursor (not explicitly shown in FIG. 5) may open a field where a user may enter comments related to administering of the drug for that time period.

Although some embodiments of the present invention have been described in detail, it should be understood that various changes, substitutions, and alterations can be made hereto without departing from the spirit and scope of the invention as defined by the appended claims.

What is claimed is:

1. A method for providing patient care, comprising:
identifying a plurality of patient characteristics of a patient who will receive a drug;
receiving information concerning the drug, the received information comprising,
one or more therapeutic break periods associated with one or more trial patients, each of the therapeutic break periods indicating a predicted range of time when the drug reaches a predetermined level of effectiveness for the associated trial patient, wherein each of the trial patients has at least one of the patient characteristics of the patient,
patient characteristic information concerning the trial patients;
determining a customized therapeutic break period customized for the patient using the received information concerning the drug and the identified patient characteristics of the patient;
generating a graph comprising a dosage axis and a date axis, the dosage axis indicating a plurality of dosage increments and the date axis indicating a plurality of dates;
for a particular one of the dosage increments, determining a date range indicated by the date axis that corresponds to the customized therapeutic break period;
indicating, on the graph, that the drug has been administered up to the determined date range;
in response to a change in the dosage of the drug, selecting another one of the dosage increments indicated by the dosage axis for determining a new date range indicated by the date axis that corresponds to the customized therapeutic break period; and
indicating, on the graph, that the drug has been administered up to the new date range at the selected dosage increment.

2. The method of claim 1, and further comprising providing a comment field in conjunction with indicating that the drug has been administered up to the determined date range.

3. The method of claim 1, and further comprising graphing the determined date range using a visual indicator that is distinguishable from other indicators.

4. The method of claim 1, wherein patient characteristic information comprises genetic information and physical characteristics of trial patients.

5. A method for providing patient care, comprising:
receiving information concerning a therapeutic break period of a drug, the therapeutic break period indicating a predicted range of time when the drug will reach a predetermined level of effectiveness for a patient;
identifying a date range that corresponds to the therapeutic break period; and
graphically displaying an indication of the therapeutic break period in conjunction with the date range for at least one dosage of the drug.

6. The method of claim 5, wherein the therapeutic break period is associated with at least one of a plurality of patient characteristics of the patient.

7. The method of claim 5, and further comprising:
generating a graph comprising a dosage axis and a date axis, the dosage axis indicating a plurality of dosage increments and the date axis indicating a plurality of dates, wherein the indication of the therapeutic break period is graphically displayed on the graph.

8. The method of claim 5, and further comprising:
generating a graph comprising a dosage axis and a date axis, the dosage axis indicating a plurality of dosage increments and the date axis indicating a plurality of dates;
indicating, on the graph, that the drug has been administered up to the identified date range; and
wherein the indication of the therapeutic break period is graphically displayed on the graph.

9. The method of claim 5, wherein the therapeutic break period is a customized therapeutic break period that is customized using patient characteristic information and therapeutic break period information of a plurality of trial patients.

10. The method of claim 5, and further comprising:
initiating a determination during the date range that the drug has not reached the predetermined level of effectiveness for the patient; and
initiating a selection of a new dosage of the drug to be administered to the patient.

11. The method of claim 5, and further comprising:
initiating a determination during the date range that the drug has not reached the predetermined level of effectiveness for the patient; and
initiating a selection of a new drug to be administered to the patient.

12. The method of claim 5, wherein the information further comprises a maximum dosage limit of the drug, and further comprising graphically displaying an indication of the maximum dosage limit.

13. A method for providing patient care, comprising:
determining a therapeutic break period of a drug, the therapeutic break period indicating a predicted range of time when the drug will reach a predetermined level of effectiveness for a patient;
generating a graph comprising a dosage axis and a time axis, the dosage axis indicating a plurality of dosage increments and the time axis indicating a plurality of time increments;
for each of the dosage increments,
graphically displaying a start time for administering the drug at a dosage level indicated by the each of the dosage increments;
using the start time, determining a time range indicated by the time axis that corresponds to the therapeutic break period;
graphically displaying a time gap between the start time and the time range corresponding to the therapeutic break period, the time gap indicated by the time axis and representing a pre-therapeutic break period; and
graphically displaying a remaining time range remaining after the time range corresponding to the therapeutic break period, the remaining time range indicated by the time axis and representing a drug saturation period.

14. The method of claim 13, and further comprising indicating a drug half-life in the graph.

15. The method of claim 13, and further comprising indicating patient information.

16. The method of claim 13, and further comprising indicating patient information, wherein the patient information includes a plurality of patient characteristics of the patient.

17. The method of claim 13, wherein the therapeutic break period is associated with at least one patient characteristic of the patient.

18. The method of claim 13, and further comprising graphically displaying the maximum dosage limit of the drug.

19. A system for providing patient care, comprising:
a computer system having a processor;
a computer readable medium coupled to the computer system, the computer readable medium comprising a program operable, when executed on the processor, to:
receive information concerning a therapeutic break period of a drug, the therapeutic break period indicating a predicted range of time when the drug will reach a predetermined level of effectiveness for a patient;
identify a date range that corresponds to the therapeutic break period; and
graphically display an indication of the therapeutic break period in conjunction with the date range for at least one dosage of the drug.

20. The system of claim 19, wherein the therapeutic break period is associated with at least one of a plurality of patient characteristics of the patient.

21. The system of claim 19, wherein the program is further operable to generate a graph comprising a dosage axis and a date axis, the dosage axis indicating a plurality of dosage increments and the date axis indicating a plurality of dates, wherein the indication of the therapeutic break period is graphically displayed on the graph.

22. The system of claim 19, wherein the program is further operable to:
generate a graph comprising a dosage axis and a date axis, the dosage axis indicating a plurality of dosage increments and the date axis indicating a plurality of dates;
indicate, on the graph, that the drug has been administered up to the identified date range; and
wherein the indication of the therapeutic break period is graphically displayed on the graph.

23. The system of claim 19, wherein the program is further operable to determine, using the graphically displayed indication of the received therapeutic break period, a customized therapeutic break period customized using a plurality of patient characteristics of the patient.

24. The system of claim 19, wherein the program is further operable to:
initiate a determination during the date range that the drug has not reached the predetermined level of effectiveness for the patient; and
initiate a selection of a new dosage of the drug to be administered to the patient.

25. The system of claim 19, wherein the program is further operable to:
initiate a determination during the date range that the drug has not reached the predetermined level of effectiveness for the patient; and
initiate a selection of a new drug to be administered to the patient.

26. The system of claim 19, wherein the information further comprises a maximum dosage limit of the drug, and program is further operable to graphically display an indication of the maximum dosage limit.

27. A method for providing patient care, comprising:
identifying one or more patient characteristics of a patient who will receive a drug;
receiving information concerning one or more therapeutic break periods associated with one or more trial patients, each of the therapeutic break periods indicating a predicted range of time when the drug reaches a predetermined level of effectiveness for the associated trial patient, wherein each of the trial patients has at least one of the patient characteristics of the patient;
receiving patient characteristic information concerning the trial patients; and
determining a customized therapeutic break period customized for the patient using the received information concerning the therapeutic break periods, patient characteristic information concerning the trial patients, and the identified patient characteristics of the patient.

28. The method of claim 27, and further comprising:
identify a date range that corresponds to the customized therapeutic break period; and
graphically display an indication of the customized therapeutic break period in conjunction with the date range for at least one dosage of the drug.

29. The method of claim 27, wherein patient characteristic information comprises genetic information and physical characteristics of trial patients.
